(19) United States
(12) Patent Application Publication
(10) Pub. No.: US 2025/0247624 A1
(43) Pub. Date: Jul. 31, 2025

(54) IMAGING APPARATUS

(71) Applicant: FUJIFILM Corporation, Tokyo (JP)

(72) Inventor: Koki HOJO, Saitama-shi (JP)

(73) Assignee: FUJIFILM Corporation, Tokyo (JP)

(21) Appl. No.: 19/035,719

(22) Filed: Jan. 23, 2025

(30) Foreign Application Priority Data
Jan. 31, 2024 (JP) 2024-012557

(51) Int. Cl. H04N 23/695; G03B 17/56; H04N 23/50

(52) U.S. Cl. CPC H04N 23/695; G03B 17/561; H04N 23/50

(57) ABSTRACT

An imaging apparatus that has a tilt mechanism of a monitor unit includes: a body part that has an imaging unit; the monitor unit; and a support member that has a first hinge supporting the body part to be rotationally movable around a first axis and a second hinge supporting the monitor unit to be rotationally movable around a second axis along the first axis. In a case where a rotational movement state of the first hinge and a rotational movement state of the second hinge are in a closed state, the first axis is disposed outside the monitor unit as viewed from a direction perpendicular to a display surface of the monitor unit, and in a case where the rotational movement state of the first hinge is in an open state, the monitor unit is rotationally movable by at least 180 degrees around the second axis.

### CROSS-REFERENCE TO RELATED APPLICATIONS

This application is based on and claims priority under 35 USC 119 from Japanese Patent Application No. 2024-012557 filed on Jan. 31, 2024, the contents of which are incorporated herein by reference.

### BACKGROUND OF THE INVENTION

### 1. Field of the Invention

The present invention relates to an imaging apparatus.

### 2. Description of the Related Art

JP2001-094845A discloses a digital camera that has a two-horizontal axis tilt mechanism and that includes a body, and a display that is housed in the body so as to expose a display unit on a rear surface of the body, in which the display is capable of reversing front and rear surfaces, one end part of a pair of support members is pivotally supported by the display so as to reverse the front and rear surfaces around a second axis, and the other end part of the pair of support members is pivotally supported by the body part so as to rotationally move around a first axis.

JP2011-124902A discloses an imaging apparatus in which a movable liquid crystal monitor is supported in a cantilevered state by a camera body via three rotation axes, and among the three rotation axes, an X-axis and a Z-axis are horizontal axes and a Y-axis is a vertical axis, and the movable liquid crystal monitor is pivotally supported so as to reverse the front and rear surfaces by the Z-axis.

### SUMMARY OF THE INVENTION

One embodiment according to the technology of the present disclosure provides an imaging apparatus in which a monitor unit is rotationally movable by 180° around an axis in an imaging apparatus including a tilt mechanism of the monitor unit.

(1)

An imaging apparatus that has a tilt mechanism of a monitor unit comprising:

a body part that has an imaging unit;

the monitor unit; and

a support member that has a first hinge supporting the body part to be rotationally movable around a first axis and a second hinge supporting the monitor unit to be rotationally movable around a second axis along the first axis,

in which, in a case where a rotational movement state of the first hinge and a rotational movement state of the second hinge are in a closed state, the first axis is disposed outside the monitor unit as viewed from a direction perpendicular to a display surface of the monitor unit, and

in a case where the rotational movement state of the first hinge is in an open state, the monitor unit is rotationally movable by at least 180° around the second axis.

(2)

The imaging apparatus according to (1),

in which the monitor unit has a first display unit and a second display unit.

(3)

The imaging apparatus according to (2),

in which the first display unit has a larger display area than the second display unit.

(4)

The imaging apparatus according to any one of (1) to (3),

in which the first hinge includes a plurality of hinges disposed at intervals along the first axis, and

the second hinge includes fewer hinges than the plurality of hinges.

(5)

The imaging apparatus according to (4),

in which the second hinge supports one end of the monitor unit in a direction of the second axis.

(6)

The imaging apparatus according to (4) or (5),

in which the first hinge includes a hinge that is disposed on a side in a first direction along the second axis with respect to the second hinge, and a hinge that is disposed on a side opposite to the first direction with respect to the second hinge.

(7)

The imaging apparatus according to any one of (1) to (6), further comprising:

a locking mechanism that fixes the monitor unit to the body part.

(8)

The imaging apparatus according to (7), further comprising:

a first locking mechanism that fixes the rotational movement state of the first hinge to the closed state; and

a second locking mechanism that fixes the rotational movement state of the second hinge to the closed state.

(9)

The imaging apparatus according to (8),

in which the first locking mechanism fixes the rotational movement state of the first hinge to the closed state by a fixed position locking mechanism of the first hinge.

(10)

The imaging apparatus according to (9),

in which the first locking mechanism biases the monitor unit to the body part by the fixed position locking mechanism.

(11)

The imaging apparatus according to any one of (8) to (10),

in which the second locking mechanism includes a protrusion portion provided on one of the monitor unit and the support member and a recess portion provided on the other of the monitor unit and the support member, and

the rotational movement state of the second hinge is fixed to the closed state by fitting between the protrusion portion and the recess portion.

(12)

An imaging apparatus that has a tilt mechanism of a monitor unit comprising:

a body part that has an imaging unit;

the monitor unit; and

a support member that has a first hinge supporting the body part to be rotationally movable around a first axis and a second hinge supporting the monitor unit to be rotationally movable around a second axis along the first axis,

in which a distance between the first axis and the second axis is longer than a distance between a portion of the monitor unit farthest from the second axis and the second axis, and

in a case where a rotational movement state of the first hinge is an open state, the monitor unit is rotationally movable by at least 180° around the second axis.

According to the present invention, it is possible to provide an imaging apparatus in which a monitor unit can be rotationally moved by 180° around an axis in an imaging apparatus including a tilt mechanism of the monitor unit.

### BRIEF DESCRIPTION OF THE DRAWINGS

FIG. 1 is a front perspective view showing an example of an imaging apparatus 1 according to the present embodiment.

FIG. 2 is a side view of the imaging apparatus 1 shown in FIG. 1 as viewed from the left side.

FIG. 3 is a rear view of the imaging apparatus illustrated in FIG. 1.

FIG. 4 is a perspective view of a support member 30 shown in FIG. 3.

FIG. 5 is a side view showing an example of the imaging apparatus 1 in which a rotational movement state of a first hinge 31 (31a, 31b) and a rotational movement state of a second hinge 32 are adjusted to a closed state.

FIG. 6 is a side view showing an example of the imaging apparatus 1 in which a rotational movement state of the first hinge 31 (31a, 31b) is adjusted to an open state.

FIG. 7 is a diagram showing an example of a low-angle state of a sub monitor 22 of a monitor unit 20.

FIG. 8 is a diagram showing an example of a low-angle state on a main monitor 21 of the monitor unit 20.

FIG. 9 is a diagram showing an example of a high-angle state on the main monitor 21 of the monitor unit 20.

FIG. 10 is a diagram showing a state in which a surface of the main monitor 21 in the monitor unit 20 is stored in a body part 10.

FIG. 11 is a diagram showing an example of a distance between a first axis A and a second axis B in the tilt mechanism.

FIG. 12 is a diagram showing an example of a first locking mechanism that fixes a rotational movement state of the first hinge 31 (31a, 31b) to a closed state.

FIG. 13 is a diagram showing an example of a second locking mechanism 40 that fixes a rotational movement state of the second hinge 32 to a closed state.

FIG. 14 is a horizontal cross-sectional view of the second locking mechanism 40 shown in FIG. 13 taken along a plane extending in a left-right and front-rear directions.

FIG. 15 is a diagram showing a modification example of the recess portion 23 in the second locking mechanism 40 of FIG. 14.

FIG. 16 is a diagram showing a modification example of the second locking mechanism 40 shown in FIG. 13.

FIG. 17 is a horizontal cross-sectional view of a second locking mechanism 40A of the modification example shown in FIG. 16 taken along a plane extending in the left-right and front-rear directions.

### DESCRIPTION OF THE PREFERRED EMBODIMENTS

Hereinafter, an example of an embodiment of the present invention will be described with reference to the drawings. In the present embodiment, the terms “upward direction”, “downward direction”, “leftward direction”, “rightward direction”, “forward direction”, and “rearward direction” are used, but these directions are relative directions set for convenience of description for the imaging apparatus shown in each drawing.

### Imaging Apparatus of Embodiment

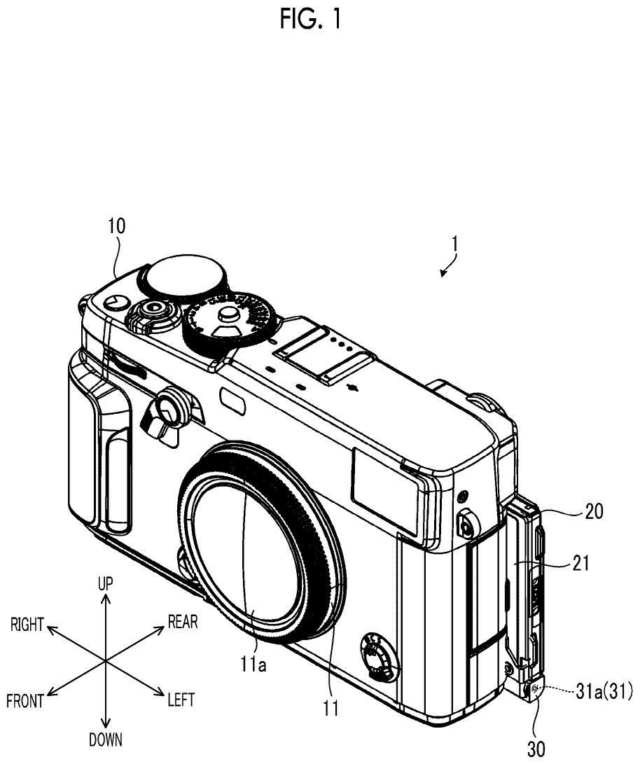

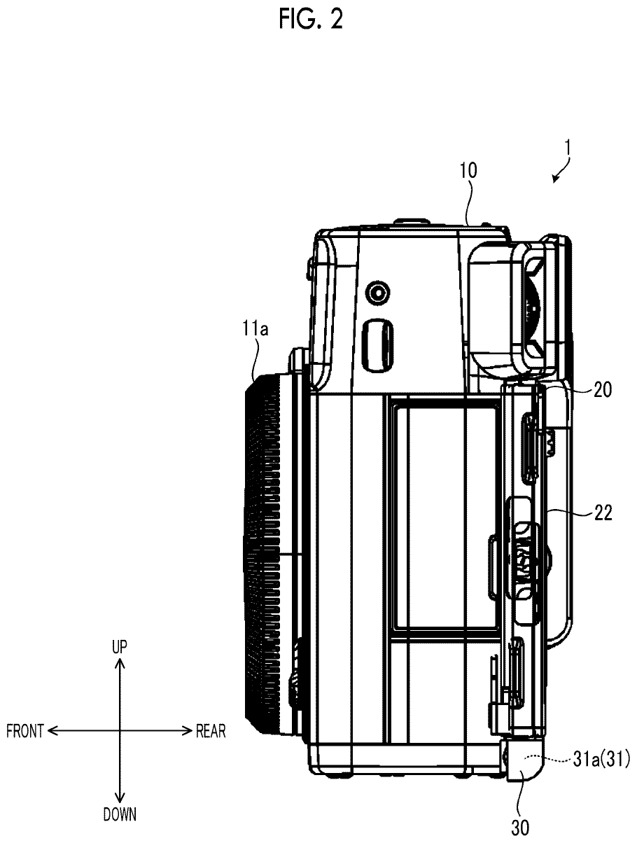

FIG. 1 is a front perspective view showing an example of an imaging apparatus 1 in the present embodiment. FIG. 2 is a side view of the imaging apparatus 1 shown in FIG. 1 as viewed from the left side. As shown in FIGS. 1 and 2, examples of the imaging apparatus include a digital camera or a single-lens reflex camera capable of imaging a motion picture. The imaging apparatus 1 comprises a body part 10, a monitor unit 20, and a support member 30 that supports the monitor unit 20 with respect to the body part 10.

The body part 10 is formed in a substantially rectangular shape as viewed from the front side (front side of the imaging apparatus 1), and has a horizontally long rectangular shape in which an upper side and a lower side are long sides and a left side and a right side are short sides among four sides thereof. A lens mounting unit 11 is provided at a front portion of the body part 10. A lens (not shown) is attachable to and detachable from the lens mounting unit 11. FIG. 1 shows the body part 10 in a state in which the lens is detached from the lens mounting unit 11 in the imaging apparatus 1. A lens cover 11a can be attached to the lens mounting unit 11 from which the lens is detached. In a case where the imaging apparatus 1 is used (in a case of imaging), the lens cover 11a is removed from the lens mounting unit 11, and the lens is mounted. In addition, the body part 10 has an imaging element (not shown) that constitutes an imaging unit together with the lens inside the body part 10.

The monitor unit 20 is provided at a rear portion of the body part 10. The monitor unit 20 includes a main monitor 21 and a sub monitor 22. The main monitor 21 is provided on one surface (for example, a front surface side) of the monitor unit 20. The sub monitor 22 is provided on a surface (for example, a rear surface side) of the monitor unit 20 opposite to the main monitor 21. The main monitor 21 and the sub monitor 22 function as a rear surface monitor of the imaging apparatus 1. A display area of the main monitor 21 is larger than a display area of the sub monitor 22. The main monitor 21 is an example of a “first display unit” according to the embodiment of the present invention. The sub monitor 22 is an example of a “second display unit” according to the embodiment of the present invention.

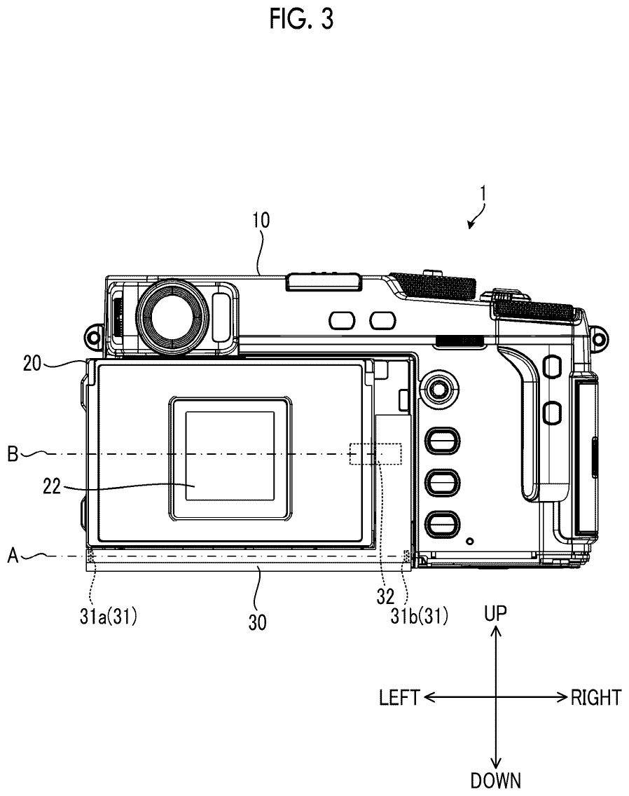

The support member 30 has a first hinge 31 (31a, 31b) and a second hinge 32, which will be described in detail with reference to FIG. 3. The first hinge 31 (31a, 31b) is a hinge that rotationally supports the body part 10. The second hinge 32 is a hinge that rotationally supports the monitor unit 20.

FIG. 3 is a rear view of the imaging apparatus 1 shown in FIG. 1. As shown in FIG. 3, a monitor unit 20 is provided at a rear portion of the body part 10. The monitor unit 20 has a substantially flat plate shape and is formed in a substantially rectangular shape as viewed from a direction perpendicular to a display surface (in the present example, a surface of the sub monitor 22). The monitor unit 20 has a horizontally long rectangular shape in which an upper side and a lower side of the four sides are long sides and a left side and a right side are short sides. The sub monitor 22 is provided in a partial region in the substantially center portion of the monitor unit 20. A captured image of the imaging target, an operation panel, or the like is appropriately displayed on the sub monitor 22. The captured image of the imaging target, the operation panel, or the like is also appropriately displayed on the main monitor 21 provided on the side opposite to the sub monitor 22. The sub monitor 22 can also function as a monitor for presentment that is capable of displaying, for example, an image indicating the current imaging setting (for example, the setting of the filter processing) set in the imaging apparatus 1.

The monitor unit 20 is supported by the support member 30 via the second hinge 32. The support member 30 is supported by the body part 10 via the first hinge 31 (31a, 31b).

The first hinge 31 (31a, 31b) has a first axis A (virtual axis) extending along a long side on a lower side of the body part 10. The expression “the first axis A is ‘along’ the side of the body part 10” means that the first axis A is parallel to the side without being separated from the side of the body part 10. The first hinge 31 (31a, 31b) includes a plurality of hinges disposed at intervals along the first axis A. The first hinge 31 shown in FIG. 3 includes two hinges consisting of a first hinge 31a disposed at a left end along the first axis A and a first hinge 31b disposed at a right end along the first axis A.

The second hinge 32 has a second axis B (virtual axis) along the first axis A. The term “along the first axis A” means that a direction in which the second axis B extends is substantially parallel to a direction in which the first axis A extends. The term “substantially parallel” includes being parallel within a range of manufacturing error or within a range of play due to looseness. The second axis B is an axis extending through a substantially central position of the monitor unit 20 in the short side direction (up-down direction). The second hinge 32 includes a smaller number of hinges than the first hinge 31. The second hinge 32 shown in FIG. 3 consists of a single hinge disposed at the right end along the second axis B. The second hinge 32 is in a cantilevered state of supporting one end (the right end in the present example) of both end parts of the monitor unit 20 in the direction of the second axis B.

The first axis A of the first hinge 31 (31a, 31b) is disposed outside the monitor unit 20 in a case of being viewed from a direction perpendicular to the display surface (in the present example, the display surface of the sub monitor 22) of the monitor unit 20. The first axis A shown in FIG. 3 is disposed on a lower side of the monitor unit 20. The first hinge 31a of the first hinges 31 (31a, 31b) is disposed on a side in a first direction along the second axis B with respect to the second hinge 32 in a case of being viewed from a direction perpendicular to the display surface of the monitor unit 20. In addition, the first hinge 31b of the first hinges 31 (31a, 31b) is disposed on an opposite side to the first direction along the second axis B with respect to the second hinge 32 in a case of being viewed from a direction perpendicular to the display surface of the monitor unit 20. In the case shown in FIG. 3, the first hinge 31a is disposed on the left side of the second hinge 32, and the first hinge 31b is disposed on the right side of the second hinge 32. The first hinge 31 (31a, 31b) rotationally supports the body part 10 around the first axis A. The second hinge 32 rotationally supports the monitor unit 20 around the second axis B.

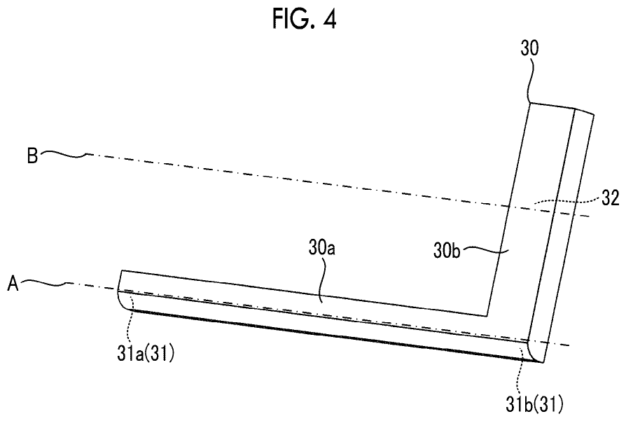

FIG. 4 is a perspective view of the support member 30 shown in FIG. 3. As shown in FIG. 4, the support member 30 includes a first support portion 30a that extends in the same direction as the first axis A and the second axis B, and a second support portion 30b that extends in a direction perpendicular to the first support portion 30a from one end part of the first support portion 30a. The support member 30 is an L-shaped member consisting of a first support portion 30a and a second support portion 30b. The first support portion 30a is provided with a first hinge 31a and a first hinge 31b that are disposed along the first axis A. The second support portion 30b is provided with a second hinge 32 that is disposed along the second axis B.

In a case where the position of the first hinge 31a is set to be on the left side of the second hinge 32 and the position of the first hinge 31b is set to be on the right side of the second hinge 32, it is necessary to secure a wide width of the first support portion 30a of the support member 30 in the left-right direction, for example, as compared with a case where the position of the first hinge 31b is set to be substantially the same position as the position of the second hinge 32 in the left-right direction. By forming the width of the first support portion 30a to be wide, the flexible substrate used as the circuit board of the monitor unit 20 can be easily wired. Specifically, the flexible substrate that is led out from the monitor unit 20 to the support member 30 side (right side) can be disposed along the first support portion 30a having a width in the support member 30, and thus wiring can be easily wired.

As described above, the imaging apparatus 1 of the present embodiment comprises the tilt mechanism composed of the support member 30 having the first hinge 31 (31a, 31b) that rotationally supports the body part 10 around the first axis A and the second hinge 32 that rotationally supports the monitor unit 20 around the second axis B.

### Tilt Mechanism of Monitor Unit 20

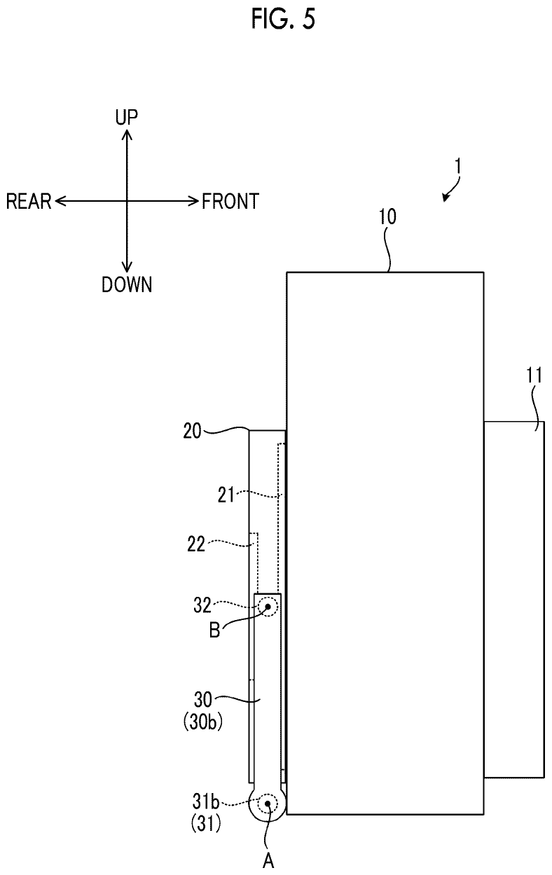

Next, the tilt mechanism of the monitor unit 20 will be described in more detail with reference to FIGS. 5 to 10. As described above, in the imaging apparatus 1, the support member 30 is rotatable with respect to the body part 10 by the first hinge 31 (31a, 31b), and the monitor unit 20 is rotatable with respect to the support member 30 by the second hinge 32. That is, in the imaging apparatus 1, the support member 30 is rotationally moved around the first axis A, and thus the opening and closing angle (visual angle) of the monitor unit 20 supported by the support member 30 with respect to the body part 10 can be adjusted. In addition, in the imaging apparatus 1, the monitor unit 20 is rotationally moved around the second axis B, and thus the main monitor 21 can be adjusted to face the rear side of the imaging apparatus 1, and the sub monitor 22 can also be adjusted to face the rear side of the imaging apparatus 1.

FIG. 5 is a side view showing an example of the imaging apparatus 1 in which the rotational movement state of the first hinge 31 (31a, 31b) and the rotational movement state of the second hinge 32 are adjusted to the closed state. The rotational movement state of the first hinge 31 (31a, 31b) being the closed state is a state in which the support member 30 is closed with respect to the body part 10. The state in which the support member 30 is closed with respect to the body part 10 is a state in which a distance between a portion (for example, the second hinge 32) of the support member 30 different from the first hinge 31 (31a, 31b) and the body part 10 is substantially minimized. The rotational movement state of the second hinge 32 being the closed state is a state in which the monitor unit 20 is closed with respect to the support member 30. The state in which the monitor unit 20 is closed with respect to the support member 30 is a state in which a distance between a portion (for example, the first hinge 31 (31a, 31b)) of the support member 30 different from the second hinge 32 and the monitor unit 20 is substantially minimized. Specifically, the monitor unit 20 is in a state of overlapping the second support portion 30b of the support member 30. Hereinafter, a state in which the rotational movement state of the first hinge 31 (31a, 31b) and the rotational movement state of the second hinge 32 are adjusted to the closed state is also referred to as a state in which the monitor unit 20 is stored in the body part 10.

In addition, in the imaging apparatus 1 shown in FIG. 5, the rotational movement state of the second hinge 32 is adjusted such that the sub monitor 22 faces the rear side of the imaging apparatus 1. This state is adjusted in the same manner as the state of the monitor unit 20 shown in FIG. 3. Hereinafter, a state in which the sub monitor 22 is adjusted and stored to face the rear side of the imaging apparatus 1 in this way is referred to as a state in which a surface of the sub monitor 22 in the monitor unit 20 is stored in the body part 10.

In a case where the monitor unit 20 is in a state of being stored in the body part 10, a configuration is adopted in which the first axis A of the first hinge 31 (31a, 31b) is disposed outside (lower side) the monitor unit 20 in a case where the imaging apparatus 1 is viewed from a direction perpendicular to the display surface of the monitor unit 20.

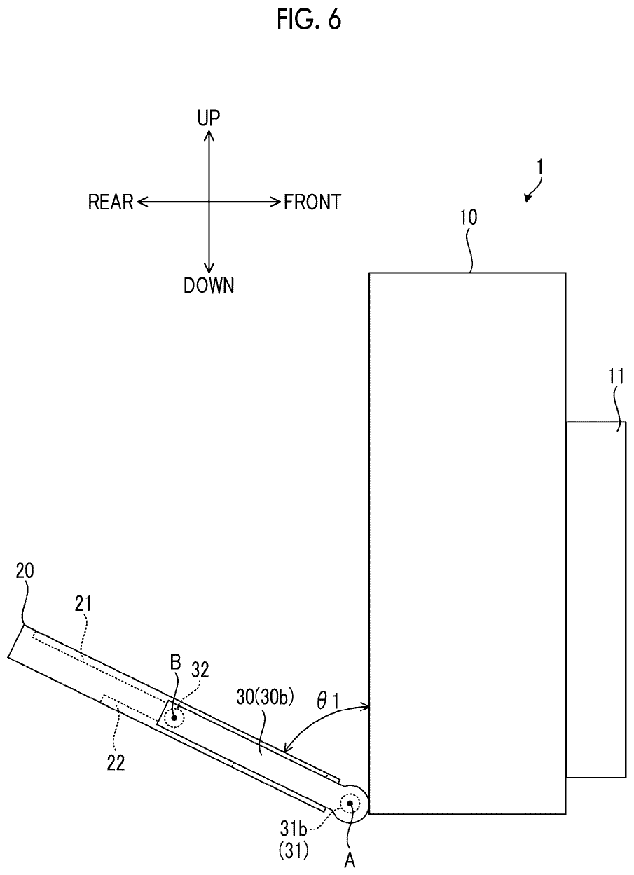

FIG. 6 is a side view showing an example of the imaging apparatus 1 in which the rotational movement state of the first hinge 31 (31a, 31b) is adjusted to the open state. The rotational movement state of the first hinge 31 (31a, 31b) being the open state is a state in which the support member 30 is opened with respect to the body part 10. The state in which the support member 30 is opened with respect to the body part 10 is a state in which a distance between a portion (for example, the second hinge 32) of the support member 30 different from the first hinge 31 (31a, 31b) and the body part 10 is separated by a certain distance or more.

The imaging apparatus 1 shown in FIG. 6 shows an example of a high-angle state in the sub monitor 22 of the monitor unit 20. The high-angle state in the sub monitor 22 refers to an angle at which the user images the subject with the imaging apparatus 1 while looking up the sub monitor 22 of the monitor unit 20 from below. In the high-angle state shown in FIG. 6, for example, the monitor unit 20 shown in FIG. 5 is adjusted to the open state with respect to the body part 10 by the first hinge 31 (31a, 31b) by an angle θ1 together with the support member 30. The angle θ1 is an angle at which the distance between the second hinge 32 and the body part 10 is separated by a certain distance or more as described above. The certain distance or more between the second hinge 32 and the body part 10 is a distance at which the monitor unit 20 is separated from the body part 10 to such an extent that the monitor unit 20 does not come into contact with the body part 10 in a case where the monitor unit 20 is rotationally moved around the second axis B.

In the example shown in FIG. 6, only the rotational movement state of the first hinge 31 (31a, 31b) is set to the open state, and the rotational movement state of the second hinge 32 is adjusted to the closed state in order to set the high-angle state, but the present invention is not limited thereto. For example, the angle of the monitor unit 20 may be adjusted to a preferred angle of the user in a state where the rotational movement state of the first hinge 31 (31a, 31b) is set to the open state and the rotational movement state of the second hinge 32 is adjusted to the open state. The rotational movement state of the second hinge 32 being the open state is a state in which the monitor unit 20 is opened with respect to the support member 30. The state in which the monitor unit 20 is open with respect to the support member 30 is a state in which a distance between a portion (for example, the first hinge 31 (31a, 31b)) of the support member 30 different from the second hinge 32 and the monitor unit 20 is not minimized. Specifically, the state is a state where the monitor unit 20 is not in a state of overlapping the second support portion 30b of the support member 30 as shown in FIG. 6, and the monitor unit 20 and the second support portion 30b of the support member 30 do not overlap each other in a state where the monitor unit 20 is rotationally moved around the second axis B. The rotational movement angle of the second hinge 32 may be configured such that friction is generated by the rotational movement and the second hinge 32 can be stopped at any position, or may be a click mechanism that can be temporarily held at a constant angle.

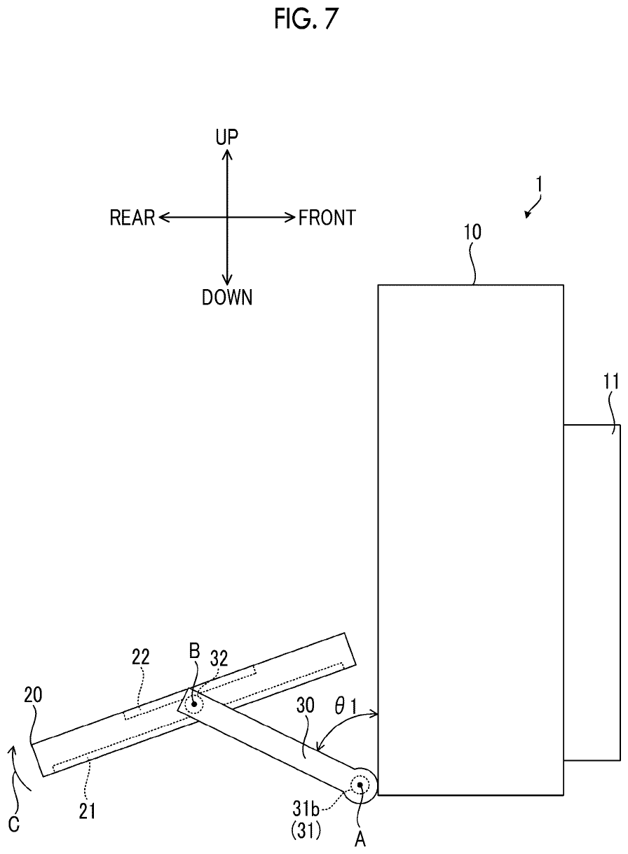

FIG. 7 is a diagram showing an example of a low-angle state of the sub monitor 22 of the monitor unit 20. The low-angle state in the sub monitor 22 refers to an angle at which the user images the subject with the imaging apparatus 1 while looking down at the sub monitor 22 of the monitor unit 20 from above. The low-angle state shown in FIG. 7 is a state in which the monitor unit 20 shown in FIG. 6 is rotationally moved around the second axis B of the second hinge 32, for example, and the sub monitor 22 is adjusted to be disposed to face the upper side. The direction in which the monitor unit 20 is rotationally moved may be, for example, a direction of an arrow C shown in FIG. 7 or may be a direction opposite to the arrow C. As described above, the monitor unit 20 is configured to be able to rotationally move at least 180° around the second axis B of the second hinge 32 in a case where the rotational movement state of the first hinge 31 (31a, 31b) is the open state.

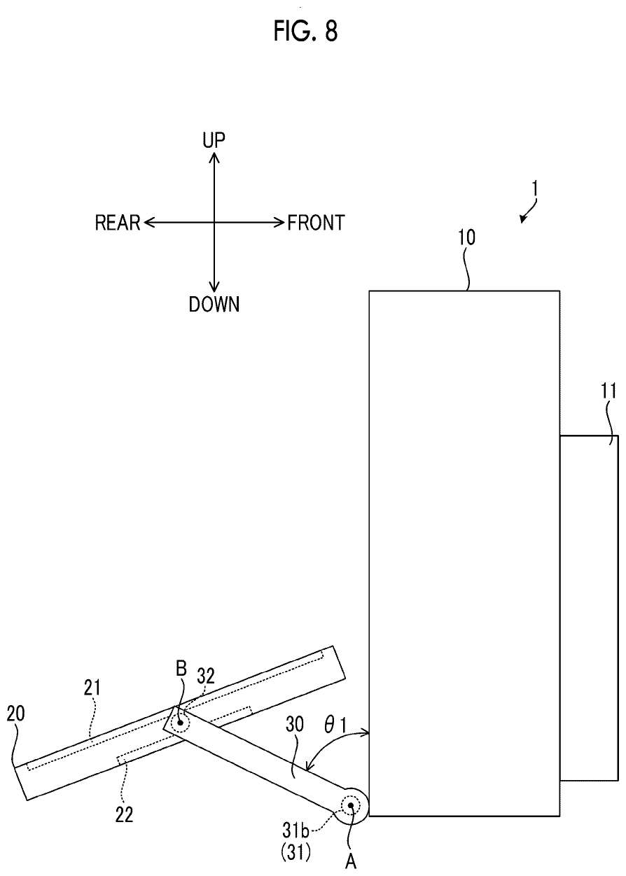

FIG. 8 is a diagram showing an example of a low-angle state of the main monitor 21 of the monitor unit 20. The low-angle state in the main monitor 21 refers to an angle at which the user images the subject with the imaging apparatus 1 while looking down at the main monitor 21 of the monitor unit 20 from above. In the low-angle state shown in FIG. 8, for example, the monitor unit 20 shown in FIG. 7 is rotationally moved by 180° around the second axis B of the second hinge 32, and the main monitor 21 is adjusted to be disposed to face the upper side.

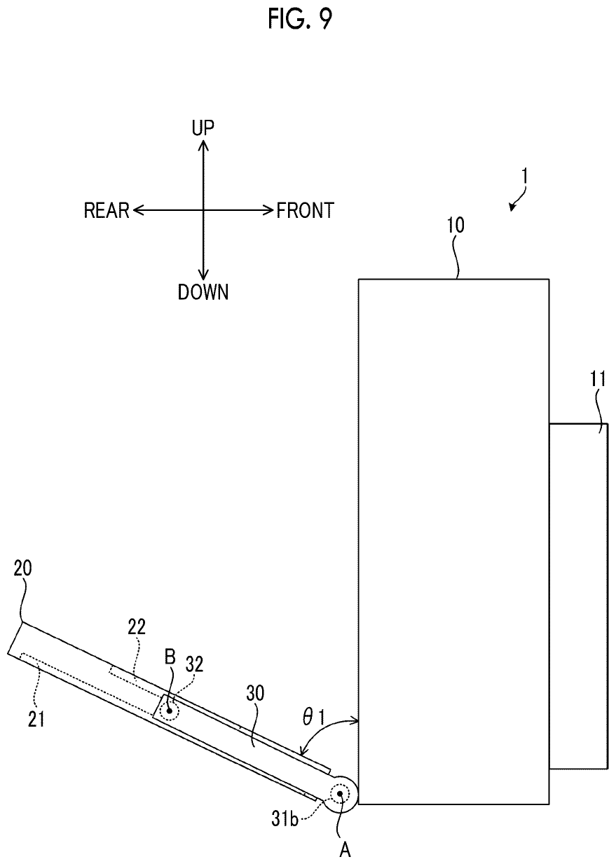

FIG. 9 is a diagram showing an example of a high-angle state of the main monitor 21 of the monitor unit 20. The high-angle state in the main monitor 21 refers to an angle at which the user images the subject with the imaging apparatus 1 while looking up the main monitor 21 of the monitor unit 20 from below. In the high-angle state shown in FIG. 9, for example, the monitor unit 20 shown in FIG. 6 is rotationally moved by 180° around the second axis B of the second hinge 32, and the main monitor 21 is adjusted to be disposed to face the lower side.

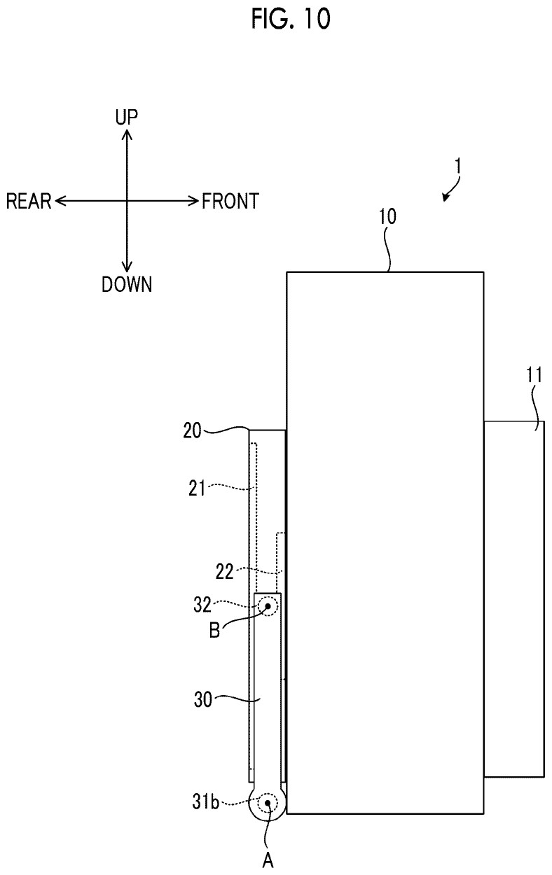

FIG. 10 is a diagram showing a state in which a surface of the main monitor 21 in the monitor unit 20 is stored in the body part 10. The state in which the surface of the main monitor 21 is stored in the body part 10 is a state in which the monitor unit 20 is stored in a state in which the rotational movement state of the second hinge 32 is adjusted such that the main monitor 21 faces the rear side of the imaging apparatus 1. The stored state of the monitor unit 20 shown in FIG. 10 is a state in which the monitor unit 20 shown in FIG. 5 is rotationally moved by 180° around the second axis B of the second hinge 32 and stored.

As described above, the imaging apparatus 1 of the present embodiment is provided with the first hinge 31 (31a, 31b) at a position (a lower side of the monitor unit 20) where the first axis A does not overlap with the monitor unit 20 in a case of being viewed from a direction perpendicular to the display surface of the monitor unit 20 as shown in FIG. 3. Accordingly, in a case where the rotational movement state of the first hinge 31 (31a, 31b) is the open state, a distance between the second axis B of the second hinge 32 that supports the monitor unit 20 and the body part 10 can be sufficiently secured with respect to the size of the monitor unit 20. Therefore, in a case where the rotational movement state of the first hinge 31 (31a, 31b) is the open state, the monitor unit 20 can be rotationally moved at least 180° around the second axis B to view any one of the main monitor 21 or the sub monitor 22 in the monitor unit 20.

### Distance Between First Axis A and Second Axis B in Tilt Mechanism

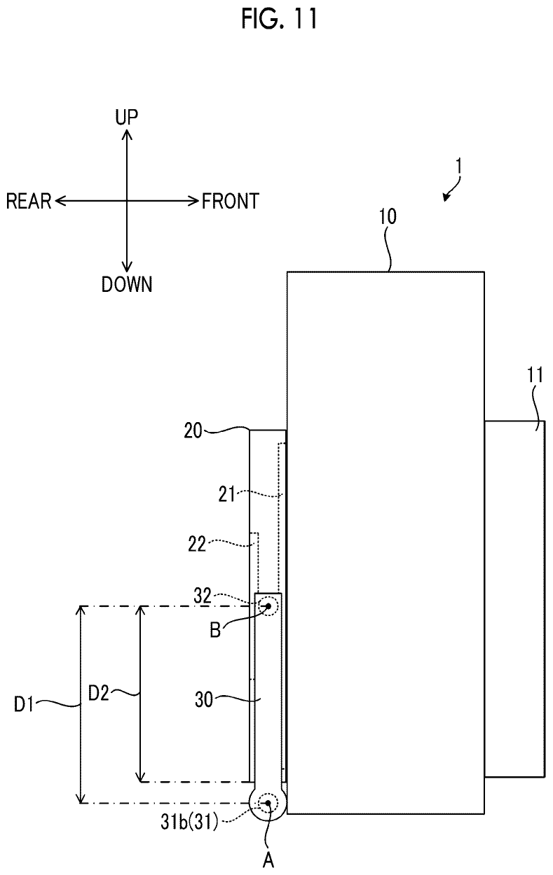

FIG. 11 is a diagram showing an example of a distance between the first axis A and the second axis B in the tilt mechanism. The imaging apparatus 1 shown in FIG. 11 is in a state in which the surface of the sub monitor 22 in the monitor unit 20 is stored in the body part 10, similarly to the imaging apparatus 1 shown in FIG. 5.

As shown in FIG. 11, in the monitor unit 20 supported by the support member 30, a distance D1 between the first axis A of the first hinge 31 (31a, 31b) and the second axis B of the second hinge 32 is configured to be longer than a distance D2 between the second axis B and a portion (end part of the monitor unit 20) of the monitor unit 20 farthest from the second axis B of the second hinge 32. Even in a case where the tilt mechanism of the imaging apparatus 1 is configured such that the distance D1>the distance D2, the monitor unit 20 can be rotationally moved by at least 180° around the second axis B of the second hinge 32 in a case where the rotational movement state of the first hinge 31 (31a, 31b) is set to the open state.

### Locking Mechanism of Monitor Unit 20

Next, a locking mechanism for fixing the monitor unit 20 to the body part 10 will be described. The imaging apparatus 1 has, as a locking mechanism that fixes the monitor unit 20 to the body part 10, a first locking mechanism that fixes the rotational movement state of the first hinge 31 (31a, 31b) to a closed state, and a second locking mechanism that fixes the rotational movement state of the second hinge 32 to a closed state.

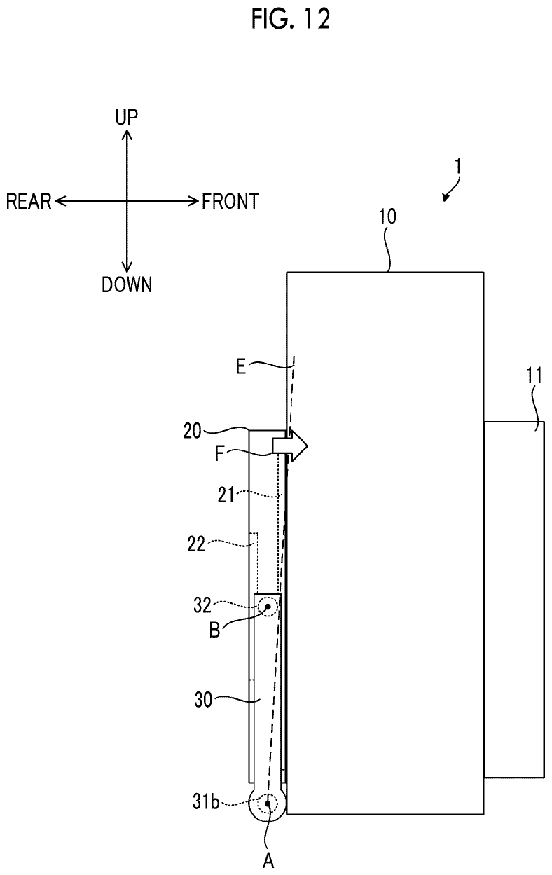

FIG. 12 is a diagram showing an example of a first locking mechanism that fixes the rotational movement state of the first hinge 31 (31a, 31b) to the closed state. The first locking mechanism fixes the rotational movement state of the first hinge 31 (31a, 31b) in a closed state by a fixed position locking mechanism capable of fixing the rotational movement state of the first hinge 31 (31a, 31b) at a predetermined rotational movement position. The fixed position locking mechanism is, for example, a click mechanism that can temporarily hold the rotational movement angle of the first hinge 31 (31a, 31b) at a plurality of discrete angles at regular intervals. The rotational movement state of the first hinge 31 (31a, 31b) being the closed state is a state in which the support member 30 is closed with respect to the body part 10 as described above.

As shown in FIG. 12, in a case where the support member 30 is rotationally moved in a direction of closing the support member 30, for example, the click mechanism of the first locking mechanism functions such that the support member 30 stops at a position indicated by a broken line E, and a biasing force F indicated by an arrow acts on the support member 30. That is, the biasing force F is applied to the support member 30 such that the upper portion side of the support member 30 is stopped in a posture inclined toward the front direction rather than the vertical direction (up-down direction). However, since the body part 10 is actually present, the monitor unit 20 comes into contact with the body part 10 and the support member 30 does not reach the position of the broken line E. As a result, the monitor unit 20 is fixed in a state of being biased to the body part 10.

According to the first locking mechanism of the monitor unit 20, in a case where the monitor unit 20 is stored in the body part 10, the biasing force F directed to the body part 10 side can be applied to the monitor unit 20. As a result, it is possible to prevent a portion (an upper portion of the monitor unit) of the monitor unit 20 on a side far from the first axis A from floating (separating) from the body part 10.

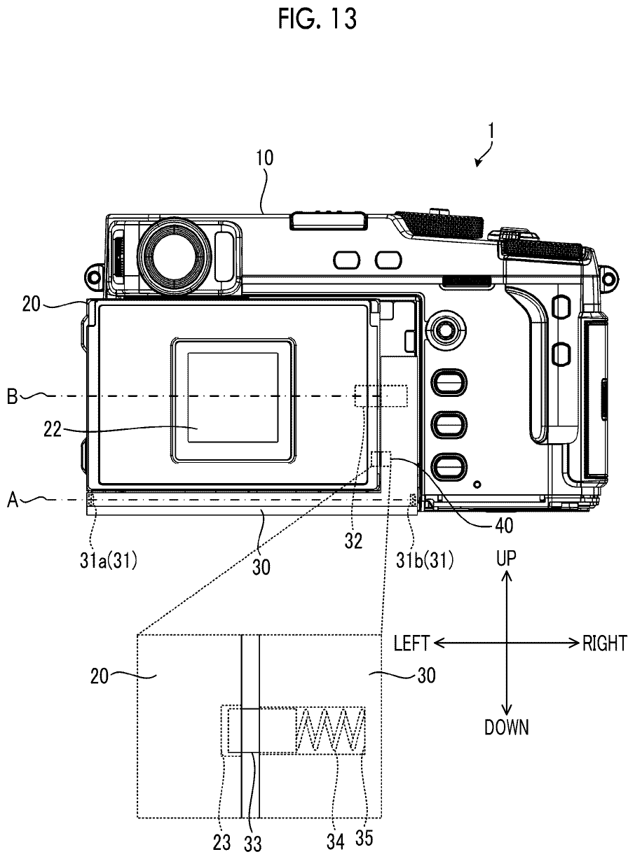

FIG. 13 is a diagram showing an example of the second locking mechanism 40 that fixes the rotational movement state of the second hinge 32 to the closed state. The second locking mechanism 40 includes a protrusion portion provided on one of the monitor unit 20 and the support member 30, and a recess portion provided on the other of the monitor unit 20 and the support member 30. The second locking mechanism 40 fixes the rotational movement state of the second hinge 32 to the closed state by fitting between the protrusion portion and the recess portion.

In the second locking mechanism 40 shown in FIG. 13, the monitor unit 20 is provided with the recess portion 23, and the support member 30 is provided with the protrusion portion 33. In addition, the second locking mechanism 40 is provided between the first axis A of the first hinge 31 (31a, 31b) and the second axis B of the second hinge 32 in the up-down direction of the imaging apparatus 1. It is preferable that the second locking mechanism 40 is provided on a side closer to the first axis A between the first axis A and the second axis B. The protrusion portion 33 of the support member 30 is disposed in the space 35 formed in the support member 30 together with the spring 34, and is configured to be capable of changing between a state where a part of the protrusion portion 33 protrudes from the space 35 and a state where the part of the protrusion portion 33 is retracted into the space 35 by the elastic force of the spring 34. The materials of the monitor unit 20 and the support member 30 in which the recess portion and the protrusion portion are formed are made of, for example, plastic such as polycarbonate.

According to this configuration, the recess portion 23 of the monitor unit 20 and the protrusion portion 33 of the support member 30 are fitted to each other, and thus the rotational movement state of the second hinge 32 can be fixed to the closed state. Accordingly, as shown in FIG. 13, in a case where the monitor unit 20 is stored in the body part 10, it is possible to prevent a portion (a lower portion of the monitor unit) of the monitor unit 20 on a side close to the first axis A from floating (separating) from the body part 10.

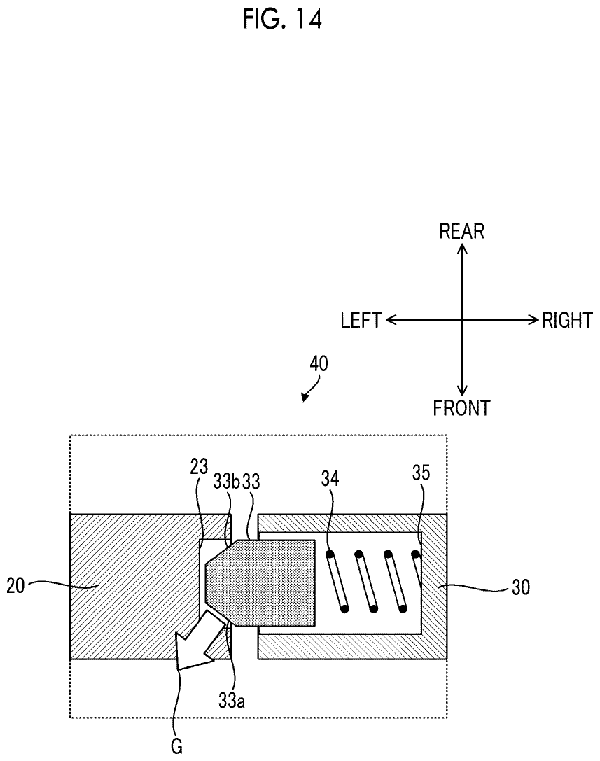

FIG. 14 is a horizontal cross-sectional view of the second locking mechanism 40 shown in FIG. 13 taken along a plane extending in the left-right and front-rear directions. As shown in FIG. 14, inclined parts 33a and 33b of which widths in the front-rear direction gradually decrease toward the distal end side are formed in the protrusion portion 33 of the support member 30. Since the inclined parts 33a and 33b are provided at the distal end part of the protrusion portion 33, in a case where the protrusion portion 33 is fitted to the recess portion 23 of the monitor unit 20, a biasing force G indicated by an arrow acts on the monitor unit 20 in the body part 10 direction (front direction) from the inclined parts 33a of the protrusion portion 33 by the elastic force of the spring 34. In addition, since the biasing force F of the click mechanism of the first locking mechanism described in FIG. 12 also acts on the second locking mechanism 40, a part of the biasing force F acts as a part of the biasing force G in the direction of the body part 10 with respect to the monitor unit 20.

According to this configuration, as shown in FIG. 13, in a case where the monitor unit 20 is stored in the body part 10, the monitor unit 20 is further biased in the body part 10 direction by the biasing force G, and it is possible to prevent a portion (a lower portion of the monitor unit) on a side close to the first axis A from floating (separating) from the body part 10.

In the example of FIGS. 13 and 14, the second locking mechanism 40 in which the recess portion 23 is provided in the monitor unit 20 and the protrusion portion 33 is provided in the support member 30 is shown, but the present invention is not limited thereto. For example, a second locking mechanism in which a protrusion portion is provided on the monitor unit 20 and a recess portion is provided on the support member 30 may be used.

### Modification Example of Recess Portion 23

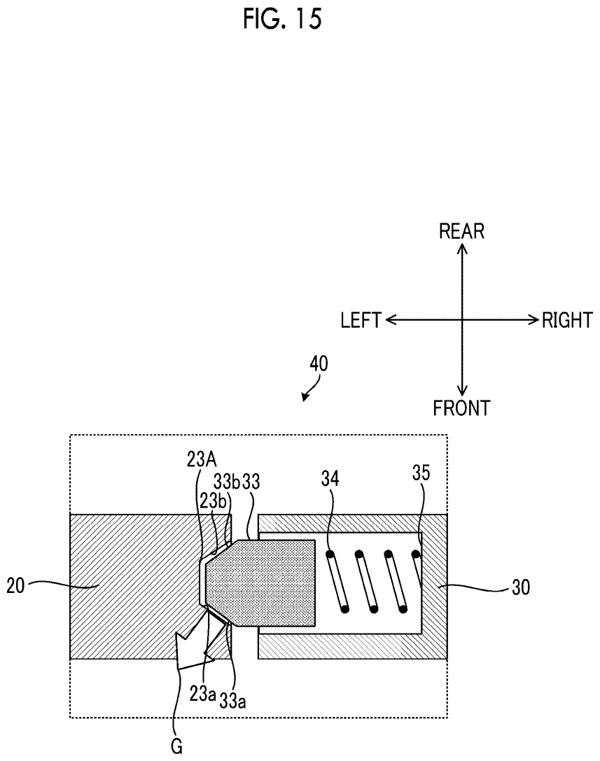

FIG. 15 is a diagram showing a modification example of the recess portion 23 in the second locking mechanism 40 of FIG. 14. As shown in FIG. 15, the shape of the recess portion 23A provided in the monitor unit 20 may correspond to, for example, the shape of the protrusion portion 33 provided in the support member 30. Specifically, the recess portion 23A may have a configuration in which the recess portion 23A has the inclined parts 23a and 23b corresponding to the inclined parts 33a and 33b of the protrusion portion 33.

According to this configuration, a contact area between the protrusion portion 33 and the recess portion 23A in a case where the protrusion portion 33 and the recess portion 23A are fitted to each other can be increased. Accordingly, a state change between a fitted state and a non-fitted state between the protrusion portion 33 and the recess portion 23A can be smoothly changed.

The material of at least one of the monitor unit 20 or the support member 30, on which the recess portion and the protrusion portion are formed, may be a member made of rubber or the like other than plastic. By using a rubber member, a friction coefficient between the recess portion and the protrusion portion can be increased, and it is possible to make it difficult for the fitting between the recess portion and the protrusion portion to be disengaged.

### Modification Example of Locking Mechanism of Monitor Unit 20

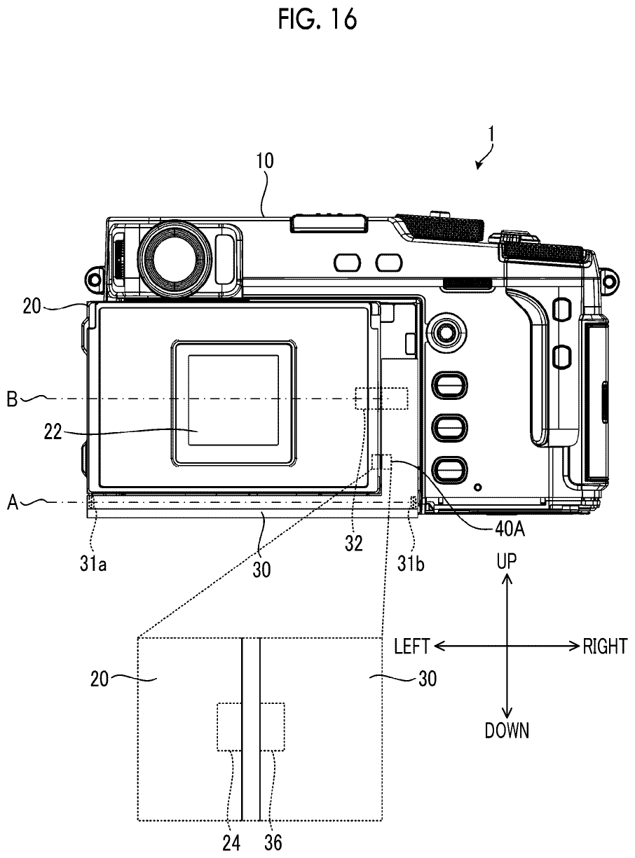

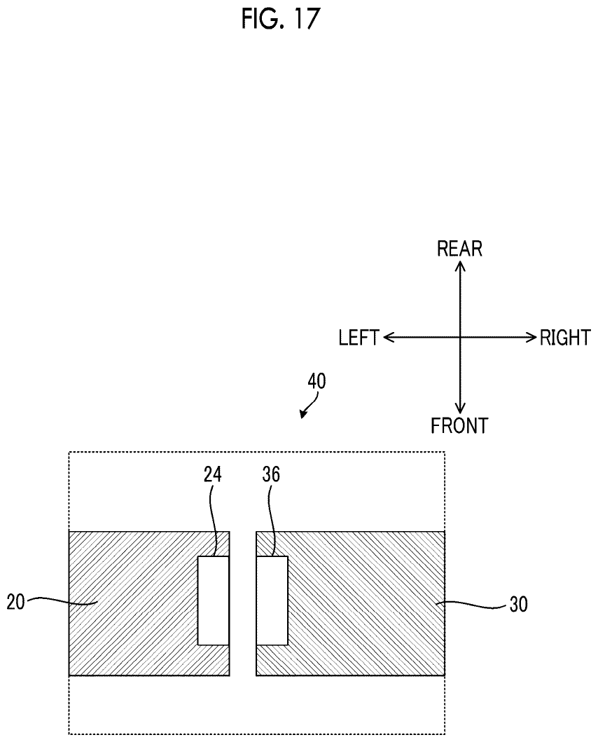

FIG. 16 is a diagram showing a modification example of the second locking mechanism 40 shown in FIG. 13. In addition, FIG. 17 is a horizontal cross-sectional view of the second locking mechanism 40A of the modification example shown in FIG. 16 taken along a plane extending in the left-right and front-rear directions. The second locking mechanism 40 of FIG. 13 fixes the rotational movement state of the second hinge 32 to the closed state by fitting between the recess portion 23 and the protrusion portion 33, whereas the second locking mechanism 40A of the modification examples of FIGS. 16 and 17 fixes the rotational movement state of the second hinge 32 to the closed state by a magnetic force between the magnets.

As shown in FIGS. 16 and 17, in the second locking mechanism 40A of the modification example, for example, the magnet 24 is provided on the monitor unit 20, and the magnet 36 is provided on the support member 30. The second locking mechanism 40A can fix the rotational movement state of the second hinge 32 to the closed state by the magnetic force between the magnet 24 and the magnet 36. Accordingly, similarly to the second locking mechanism 40 shown in FIG. 13, in a case where the monitor unit 20 is stored in the body part 10, it is possible to prevent a portion (a lower portion of the monitor unit) of the monitor unit 20 on a side close to the first axis A from floating (separating) from the body part 10.

### EXPLANATION OF REFERENCES

1: imaging apparatus
10: body part
11: lens mounting unit
11a: lens cover
20: monitor unit
21: main monitor
22: sub monitor
23, 23A: recess portion
23a, 23b, 33a, 33b: inclined part
24, 36: magnet
30: support member
30a: first support portion
30b: second support portion
31, 31a, 31b: first hinge
32: second hinge
33: protrusion portion
34: spring
35: space
40, 40A: second locking mechanism

What is claimed is:

1. An imaging apparatus that has a tilt mechanism of a monitor unit, the imaging apparatus comprising:
a body part that has an imaging unit;
the monitor unit; and
a support member that has a first hinge supporting the body part to be rotationally movable around a first axis and a second hinge supporting the monitor unit to be rotationally movable around a second axis along the first axis,
wherein, in a case where a rotational movement state of the first hinge and a rotational movement state of the second hinge are in a closed state, the first axis is disposed outside the monitor unit as viewed from a direction perpendicular to a display surface of the monitor unit, and
in a case where the rotational movement state of the first hinge is in an open state, the monitor unit is rotationally movable by at least 180 degrees around the second axis.

2. The imaging apparatus according to claim 1,
wherein the monitor unit has a first display unit and a second display unit.

3. The imaging apparatus according to claim 2,
wherein the first display unit has a larger display area than the second display unit.

4. The imaging apparatus according to claim 1,
wherein the first hinge includes a plurality of hinges disposed at intervals along the first axis, and
the second hinge includes fewer hinges than the plurality of hinges.

5. The imaging apparatus according to claim 4,
wherein the second hinge supports one end of the monitor unit in a direction of the second axis.

6. The imaging apparatus according to claim 4,
wherein the first hinge includes a hinge that is disposed on a side in a first direction along the second axis with respect to the second hinge, and a hinge that is disposed on a side opposite to the first direction with respect to the second hinge.

7. The imaging apparatus according to claim 1, further comprising:
a locking mechanism that fixes the monitor unit to the body part.

8. The imaging apparatus according to claim 7, further comprising:
a first locking mechanism that fixes the rotational movement state of the first hinge to the closed state; and
a second locking mechanism that fixes the rotational movement state of the second hinge to the closed state.

9. The imaging apparatus according to claim 8,
wherein the first locking mechanism fixes the rotational movement state of the first hinge to the closed state by a fixed position locking mechanism of the first hinge.

10. The imaging apparatus according to claim 9,
wherein the first locking mechanism biases the monitor unit to the body part by the fixed position locking mechanism.

11. The imaging apparatus according to claim 8,
wherein the second locking mechanism includes a protrusion portion provided on one of the monitor unit and the support member and a recess portion provided on the other of the monitor unit and the support member, and
the rotational movement state of the second hinge is fixed to the closed state by fitting between the protrusion portion and the recess portion.

12. An imaging apparatus that has a tilt mechanism of a monitor unit comprising:
a body part that has an imaging unit;
the monitor unit; and
a support member that has a first hinge supporting the body part to be rotationally movable around a first axis and a second hinge supporting the monitor unit to be rotationally movable around a second axis along the first axis,
wherein a distance between the first axis and the second axis is longer than a distance between a portion of the monitor unit farthest from the second axis and the second axis, and
in a case where a rotational movement state of the first hinge is an open state, the monitor unit is rotationally movable by at least 180 degrees around the second axis.
